(19) United States
(12) Patent Application Publication
(10) Pub. No.: US 2016/0041078 A1
(43) Pub. Date: Feb. 11, 2016

(54) APPARATUS FOR DETECTING PARTICLES

(71) Applicant: LG ELECTRONICS INC., Seoul (KR)

(72) Inventors: Hyun Jin PARK, Seoul (KR); Jung Chul SHIN, Seoul (KR); Oe Dong KIM, Seoul (KR); Hye Kyoung SEO, Seoul (KR); Tae Hyung KIM, Seoul (KR)

(73) Assignee: LG ELECTRONICS INC., Seoul (KR)

(21) Appl. No.: 14/684,066

(22) Filed: Apr. 10, 2015

(30) Foreign Application Priority Data
Aug. 11, 2014 (KR) 10-2014-0103640

(51) Int. Cl. G01N 15/00; G01N 27/04

(52) U.S. Cl. CPC G01N 15/00; G01N 27/04

(57) ABSTRACT

A particle detection apparatus is disclosed, the apparatus including a detector configured to detect particles in an inflowing solution using a first signal applied to a first electrode, the first signal including a direct current (DC) voltage and an alternating current (AC) voltage; and a signal processor configured to provide the first signal to the detector and to detect a second signal measured by a second electrode.

Pursuant to 35 U.S.C. §119 (a), this application claims the benefit of earlier filing date and right of priority to Korean Patent Application No. 10-2014-0103640 filed on Aug. 11, 2014, the contents of which are hereby incorporated by reference in their entirety.

### BACKGROUND OF THE DISCLOSURE

1. Field

The teachings in accordance with the exemplary embodiments of this present disclosure generally relate to an apparatus for detecting particles configured to detect concentration of particles in liquid.

2. Background

In general, methods for measuring concentration of particles in liquid can be categorized into two types, that is, a counting method and a non-counting method. The non-counting method uses a principle of measuring changes in chemical or electrical reaction that occurs in several test subjects. The non-counting method uses a material that reacts on a particular object when a desired particular object is to be measured. The non-counting method may be advantageous to measurement of concentration of individual objects, but disadvantageous in measurement of low concentration because desired measurement objects must be gathered and measured. Another disadvantage is that development of detection materials such as coating or dyeing of specific antibody is required, and a developer or a user must be equipped with a certain level of proficiency and understandability.

Due to these and other disadvantages, a particle concentration measuring device has grown with an emphasis on a method of counting the number of particles. One of the currently representative examples is an electric counting method and an optical counting method is also currently under development.

The electric counting method determines concentration of particles through measured number of particles by measuring a difference in electric signals that change when particles continuously pass through a measurement area. Although the electric counting method may be advantageous because of being simple in realization and no requirement of separate processing for measurement, the electric counting method also suffers from disadvantages in that measurement is possible only for solvent of high electric conductivity such as a phosphate buffered saline (PBS).

Thus, apparatuses using the electric counting method disadvantageously perform measurements by mixing, by a user, a solution of high electric conductivity such as PBS or a solution having a high electric conductivity similar to that of PBS in order to measure a sample contained in a solution of low electric conductivity. Furthermore, the optical counting method determines presence or absence of particles by way of characteristic shape thereof using a scattering phenomenon generated when a laser light source passes a cell coupled with phosphor, using a scattering of particles in a particular wavelength range, or using excitation and/or light emitting characteristic.

The optical counting method has an advantage over the electric counting method in that there is little limitation in selecting measurement solvents because of being freed from the problem involving electric conductivity of measured solution. However, the optical counting method still has a limitation relative to small sized cells because of requirement of obtainment for space in order to determine the changes by receiving excitation of light.

Still another disadvantage of the optical counting method is that cells may be deteriorated quality-wise due to reaction with samples, and a configuration for light emitting and receiving units is expensive.

### SUMMARY OF THE DISCLOSURE

The present disclosure is to provide an apparatus for detecting particles (hereinafter referred to as “particle detection apparatus, or simply apparatus”) easy in measurement by providing a user convenience.

In one general aspect of the present disclosure, there may be provided an electrode and a direct current (DC) voltage and an alternating current (AC) voltage are simultaneously applied to the electrode.

In the other general aspect of the present disclosure, there may be provided a particle detection apparatus, the apparatus comprising: a detector configured to detect particles in an inflowing solution using a first signal applied to a first electrode, the first signal including a direct current (DC) voltage and an alternating current (AC) voltage; and a signal processor configured to provide the first signal to the detector and to detect a second signal measured by a second electrode.

In some exemplary embodiment of the present invention, the detector may comprise a first main channel configured to receive the solution, a second main channel configured to output the solution, a measurement channel interposed between the first and second channels, and having a width narrower than that of the first and second main channels, the first electrode on a bottom surface of the first main channel, and the second electrode on a bottom surface of the second main channel.

In some exemplary embodiment of the present invention, the detector may further comprise an injector configured to inject the solution into the first main channel, and a discharger configured to discharge the solution from the second main channel.

In some exemplary embodiment of the present invention, the width of measurement channel may be determined between two times to 50 times the size of a particle to be measured.

In some exemplary embodiment of the present invention, the DC voltage may be in the range of 0.1V to 20V.

In some exemplary embodiment of the present invention, the AC voltage may be in the range of 0.1V to 20V.

In some exemplary embodiment of the present invention, the signal processor may comprise a processor configured to generate a third signal of a predetermined period with the DC voltage, an oscillator configured to oscillate the third signal to generate the first signal where the DC and AC voltages are coupled, and a signal detector configured to filter the second signal from the second electrode by a predetermined band and amplify the filtered second signal.

In another general aspect of the present disclosure, there may be provided a particle detection apparatus, the apparatus comprising: a first channel; a second channel connected to the first channel; a third channel between the first and second channels and having a width narrower than that of the first and second channels; a first electrode on a bottom surface of the first channel; and a second electrode on a bottom surface of the second channel, wherein a DC voltage and an AC voltage are simultaneously applied to the first electrode.

In some exemplary embodiment of the present invention, the DC voltage may be in the range of 0.1V to 20V.

In some exemplary embodiment of the present invention, the AC voltage may be in the range of 0.1V to 20V

In some exemplary embodiment of the present invention, a frequency of the AC voltage may be in the range of 100 Hz to 10 MHz.

In some exemplary embodiment of the present invention, the width of third channel may be determined between two times to 50 times the size of a particle to be measured.

In some exemplary embodiment of the present invention, each of the first and second electrodes may be manufactured by a semiconductor process.

In some exemplary embodiment of the present invention, each of the first and second electrodes may include any one of Pt, Cr, Ti, Cu, Ag, Au and Al.

In some exemplary embodiment of the present invention, each of the first, second and third channels may be manufactured by a semiconductor process.

In some exemplary embodiment of the present invention, each of the first, second and third channels may be made of non-conductive material.

In some exemplary embodiment of the present invention, the apparatus may further comprise: an injector configured to inject solution into the first channel at a part of the first channel.

In some exemplary embodiment of the present invention, the apparatus may further comprise: a discharger configured to discharge the solution at a part of the second channel.

### ADVANTAGEOUS EFFECTS OF THE DISCLOSURE

The exemplary embodiments of this present disclosure has an advantageous effect in that particles can be detected from a liquid of low electric conductivity whereby concentration of particle can be measured.

Another advantageous effect is that a separate specimen for detecting particles can be dispensed with to provide a user convenience.

Still another advantageous effect is that detection of particles can be made in real time whereby time for measurement can be reduced and a price of particle detection apparatus can be reduced.

### BRIEF DESCRIPTION OF DRAWINGS

FIG. 1 is an exemplary view illustrating a principle applied to the present disclosure.

FIG. 2 is a schematic view illustrating a principle of detecting particles in a state where an electric field is applied by an AC voltage in a fluid.

FIGS. 3A and 3B are exemplary views illustrating a principle according to an exemplary embodiment of the present disclosure.

FIG. 4 is an exemplary view illustrating a principle according to the present disclosure.

FIG. 5 is a block diagram illustrating a particle detection system according to an exemplary embodiment of the present disclosure.

FIG. 6 is an exemplary view illustrating a particle detection system according to an exemplary embodiment of the present disclosure.

FIG. 7 is an exemplary enlarged view of a part of a detector in FIG. 5.

FIG. 8 is an exemplary view illustrating an impedance change according to a position of particle in a channel.

FIG. 9 is a mimetic diagram illustrating a detector connected to a signal processor configured to drive the detector according to the present disclosure.

FIG. 10 is an exemplary view illustrating a voltage applied to an electrode.

FIG. 11 is a detailed block diagram illustrating a signal processor according to an exemplary embodiment of the present disclosure.

FIG. 12 is an exemplary view illustrating a signal characteristic detected by a signal detector.

FIG. 13 is an exemplary view illustrating changes in measurement in response to a DC voltage.

### DETAILED DESCRIPTION OF THE DISCLOSURE

Various exemplary embodiments will be described more fully hereinafter with reference to the accompanying drawings, in which some exemplary embodiments are shown. The present inventive concept may, however, be embodied in many different forms and should not be construed as limited to the example embodiments set forth herein. Rather, the described aspect is intended to embrace all such alterations, modifications, and variations that fall within the scope and novel idea of the present disclosure.

Hereinafter, exemplary embodiments of the present disclosure will be described in detail with reference to the accompanying drawings.

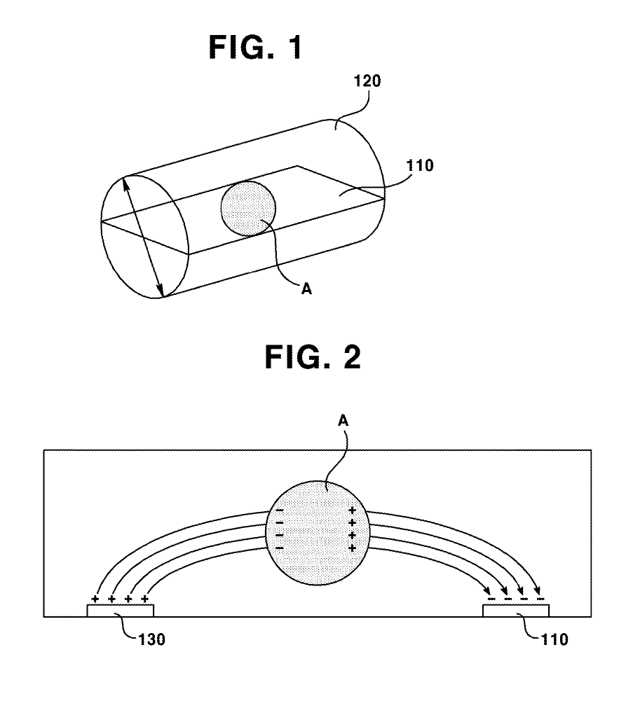

FIG. 1 is an exemplary view illustrating a principle applied to the present disclosure, where changes in electric signal in response to movement of particles in a flowing fluid are explained.

Referring to FIG. 1, impedance change may occur as much as volume of the particle in a pre-formed electric field, when a particle (A) passes over an electrode (110) in a channel (120). The impedance change allows recognizing that the particle is positioned in a measurement area. At this time, the impedance change may be expressed by the following Equation.

$$Δ R / {R}_{m} = ( \frac{{d}_{p}^{3}}{{D}_{t}^{2} {L}_{t}} ) = \frac{3}{2} Φ \qquad [ Equation 1 ]$$

where, Dₜ is a length of an electrode (110), dₚ is a diameter of a particle (A), Lₜ is a length of a measurement channel (120) and Rₘ is a total resistance.

The present disclosure used this principle. That is, basically, an electrode is positioned between areas to be measured, an electric stimulation is applied thereinto and an electric signal is applied for measurement.

A conventional method has been disclosed where a DC voltage, as an electric signal, is applied for measurement, but this conventional method basically measures an impedance change generated by obstruction of flow in electric field by non-conductive particles, the measurement method of which is useable only for liquid of high electric conductivity.

In this case, when measurement is conducted in a liquid of low electric conductivity such as purified water or city water, an impedance difference relative to particles is great because impedance of liquid per se is great, and therefore it is difficult to detect a signal. Furthermore, the liquid with a low electric conductivity generally has a high impedance to increase influence of noise during measurement. Even if impedance of particle and impedance of fluid have a similar physical property, and when polarization occurs, the flow of current into the particle is further interrupted at a border between a particle and an electrolyte, whereby additional current interruption effect can be obtained irrespective to impedance of solvent caused by passage of particle to thereby increase the magnitude of detection signal.

Thus, monitoring is made only on changes in a band applied with a voltage of particular frequency in order to detect a minute fine signal from noise, and noise of other bands is removed to improve the performance of signal detection, and to this end, application of AC voltage is required.

FIG. 2 is a schematic view illustrating a principle of detecting particles in a state where an electric field is applied by an AC voltage in a fluid.

That is, when an AC voltage is applied to an applied electrode (130) in a fluid, particles are positioned among the electric field to block the flow of electric field. At this time, a difference of electric signals as much as interruption level generally becomes an indicator for detecting presence or absence of particles.

When polarization phenomenon increases even if impedance of particle and that of fluid have a similar physical property, the flow of current into the particle is further interrupted by and at a boundary surface between the particle and the electrotype, whereby an additional current interruption regardless of impedance of solvent as the particle passes can be obtained to greatly increase the magnitude of detection signal. However, even in this case, only small amount of current moves in a liquid having a low electric conductivity to make it disadvantageously difficult to detect a signal.

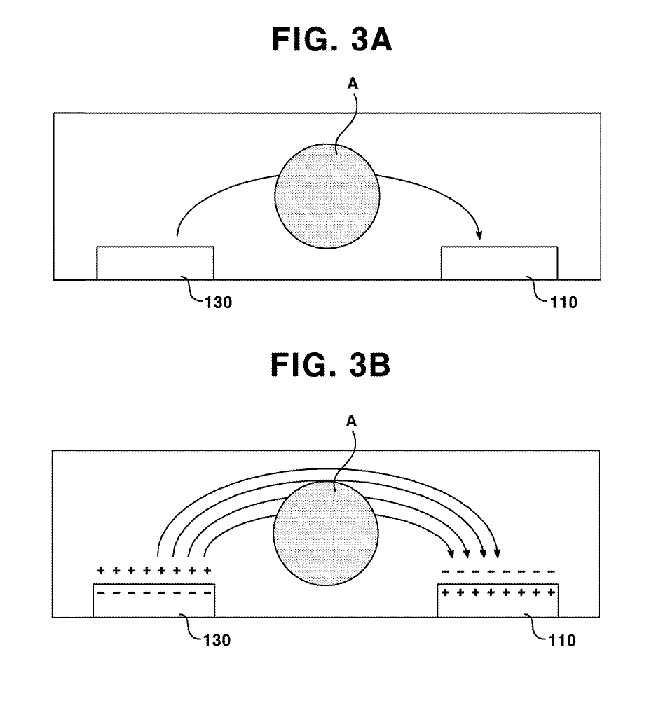

FIGS. 3a and 3b are exemplary views illustrating a principle according to an exemplary embodiment of the present disclosure, where FIG. 3a illustrates a state prior to application of DC voltage, and FIG. 3b illustrates a state where DC voltage is applied.

When electrodes {applied electrode (130) and measurement electrode (110)} are positioned in a liquid, and a DC voltage is applied to the applied electrode (130), an electrical double layer is formed on surfaces of the electrodes (130 and 110). The electrical double layer starts where, when a DC voltage is applied, electric charges are re-distributed on the surfaces of the electrodes (130 and 110), and ions of opposite electric charges are evenly and temporarily distributed around the electrodes. Subsequently, distribution of electric charges on the surfaces of the electrodes (130 and 110) reaches equilibrium, and two opposite electric charges are distributed on the surfaces of the electrodes.

In addition, some of the ions are absorbed into the surfaces of the electrodes (130 and 110), and polar molecules in the electrolyte such as water particles are aligned on the surfaces of the electrodes (130 and 110) with directional nature. The electrical double layer thus formed is neutral in terms of electricity, and the mutually opposite electric charges are arranged by being divided by a border to form a large battery with two layers. The characteristics of a current flowing in a fluid of this state may be explained by dividing to a Faraday current and a non-Faraday current, where the non-Faraday current is a current generated when re-arrangement occurs with an electrical double layer as a border, and the Faraday current is a current generated when an ion directly moves between the electrodes (130 and 110) and the electrolyte.

In short, as illustrated in FIGS. 3a and 3b, flow of current increases that obstructs as much as the volume of the passing particle as the magnitude of a total current in a channel increases due to the flow of current generated when the electric charge moves, and this principle shows a great change in signal due to the movement of particle even in a liquid of low electrical conductivity.

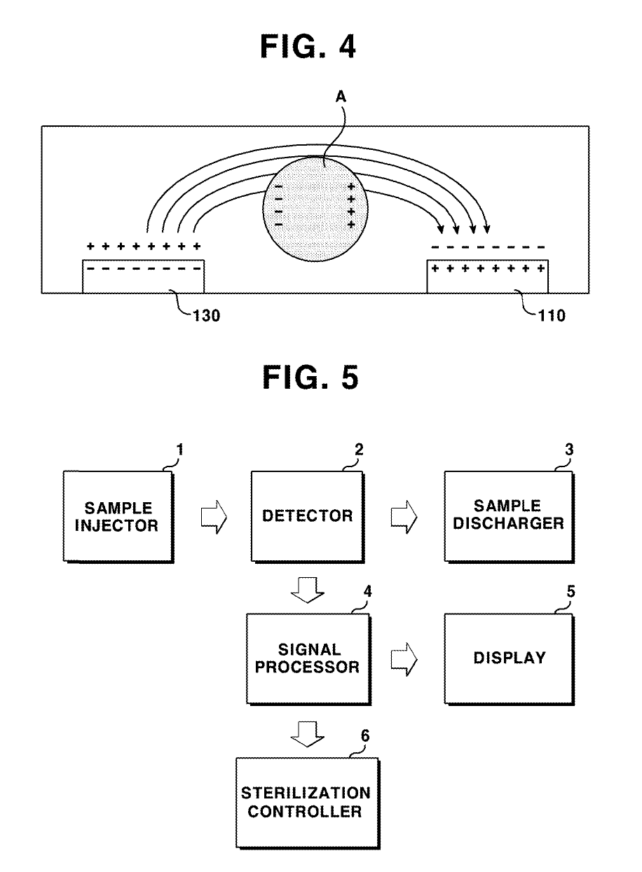

FIG. 4 is an exemplary view illustrating a principle according to the present disclosure, where DC voltage and AC voltage are simultaneously applied.

That is, FIG. 4 illustrates the simultaneous occurrence of polarization phenomenon explained in FIG. 2 and the current density increase phenomenon explained with reference to FIGS. 3a and 3b.

When this phenomenon occurs, a current density first increase in the minute liquid to further increase the possibility of interrupting the flow of current when the particle moves, and as a result, changes in electric signal increase over a measurement by an AC voltage only according to the prior art. At this time, the changes in electric signal is generated by the change as much as the volume occupied by a particle that obstructs the flow of current inside the electrolyte, and in the present disclosure, a particle in an electric field generates a polarization due to an additionally formed AC voltage, to accomplish an effect of additionally obstructing the flow of current on a surface between the electrolyte and the particle and to further increase the difference of electric signal.

That is, the present disclosure is configured in a manner such that AC voltage and DC voltage for measurement are simultaneously applied to induce an additional polarization phenomenon, whereby magnitude of signal can be improved. When the AC voltage and the DC voltage for voltage measurement are simultaneously applied, ion movement inside a liquid can be activated to thereby strengthen the movement of electric charges, i.e., to strengthen the magnitude of current.

Thus, the present disclosure employs an electric counting method to detect a particle in a liquid of low electric conductivity, whereby concentration of particle can be measured, no separate sample insertion or treatment processes are required to facilitate the usage and the accuracy of measurement can be increased.

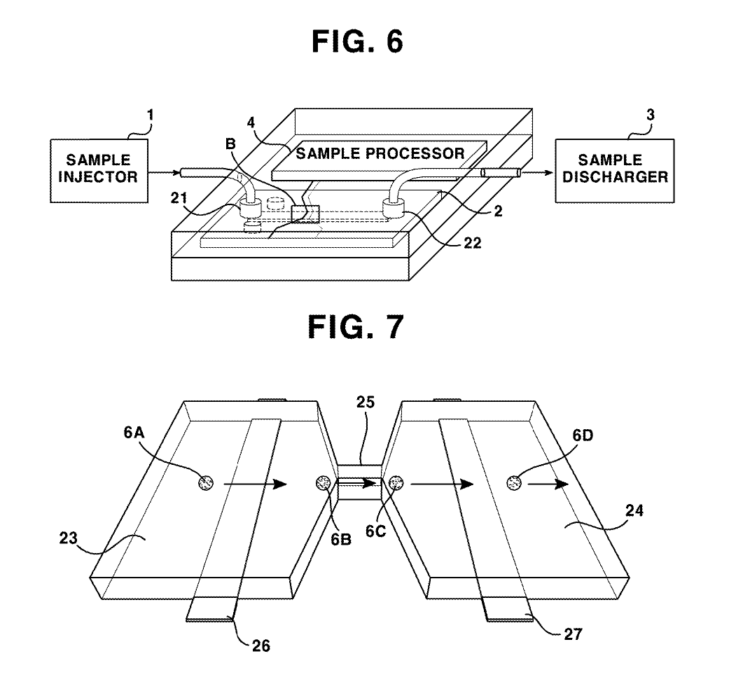

FIG. 5 is a block diagram illustrating a particle detection system according to an exemplary embodiment of the present disclosure, and FIG. 6 is an exemplary view illustrating a particle detection system according to an exemplary embodiment of the present disclosure.

The particle detection system according to the exemplary embodiment of the present disclosure is a device for monitoring a liquid state, and may be installed on a water purifier, a water softener, a refrigerator, an air conditioner, a toilet and a wash basin to determine a concentration of sample according to detection of particles inside a sample.

Referring to FIGS. 5 and 6, the particle detection system according to the exemplary embodiment of the present disclosure may include a sample injector (1), a detector (2), a sample discharger (3), and a signal processor (4), and may further include a display (5) or a sterilization controller (6).

The sample injector (1) may inject a to-be-measured sample (hereinafter referred to as sample) into the detection device (2) of the present disclosure. Although the prior art has increased the electric conductivity by mixing a separate solvent (e.g., PBS) during injection, only a sample including a particle may be straightly injected without a separate processing according to the present disclosure.

At this time, the sample injector (1) may include inject the sample to an inlet (21) of the detector (2) and may include an injector pump. When the sample is injected into the detector (2) through the sample injector (1), fluid including a particle flows through a main channel of the detector. FIG. 6 is an enlarged view of a part of the detector of FIG. 5.

Referring to FIG. 6, the detector (2) may be formed of a fine chip structure, and may include first and second main channels (23 and 24), a measurement channel (25) interposed between the first and second channels (23 and 24), an applied electrode (26) arranged at a bottom surface of the first main channel (23), and a measurement electrode (27) arranged at a bottom surface of the second main channel (24).

The applied electrode (26) may be simultaneously applied with a DC voltage and an AC voltage from the signal processor (4). At this time, the range of DC voltage and AC voltage may be respectively within 0.1V to 20V, and a frequency of AC voltage may be determined within a range of 100 Hz to 10 MHz. The applied electrode (26) and the measurement electrode (27) may be manufactured by a semiconductor manufacturing process, the detailed explanation of which is omitted as it is well known art. The material of the applied electrode (26) and the measurement electrode (27) may be any one of Pt, Cr, Ti, Cu, Ag, Au and Al, for example.

The width of the applied electrode (26) and the measurement electrode (27) may be determined within a range of 5 μm to 100 μm. The first and second channels (23 and 24) and the measurement channel (25) may be manufactured by general manufacturing methods such as semiconductor manufacturing method, materials of which may be of non-conductive materials such as polydimethylsiloxane (PDMS), glass and plastic.

The width of measurement channel (25) may be determined between twice to 50 times of the size of a particle to be measured, and the size of the particle may be between 1 μm and 10 μm, and the particle may be microorganism including bacteria or a particle of similar size.

The first main channel (23) may be connected to an inlet (21) to allow the sample injected through the inlet (21) to flow. When the sample is injected to the inlet (21) through the sample injector (1), the particle may move to a position in the order of 6A→6B→6C→6D. When the particle moves thus explained, flow of electric field formed between the applied electrode (26) and the measurement electrode (27) may be obstructed, and the measurement channel (25) can realize a particle detection characteristic in response to changes in electric signal caused by sudden changes in resistance.

At this time, the outputted detection signal obstructs the flow of electric field as the particle moves from 6A to 6D to gradually increase the impedance. But the impedance reaches the peak at a GB where a fluid pass suddenly changes to allow the measurement channel (25) to maintain high impedance. Then, the impedance shows a reducing characteristic after passing the 6C position.

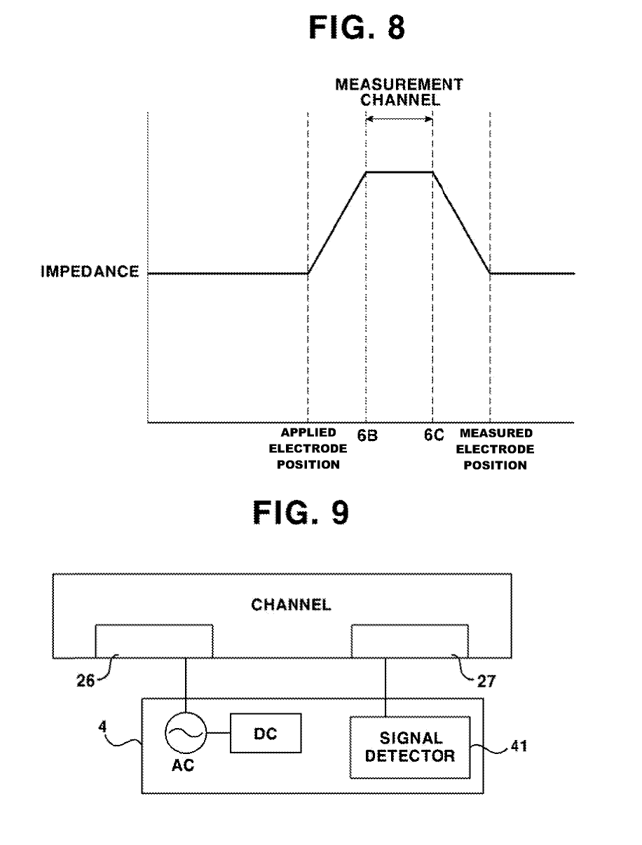

FIG. 8 is an exemplary view illustrating an impedance change according to a position of particle in a channel, where it can be noted that highest impedance is shown at the measurement channel (25). FIG. 9 is a mimetic diagram illustrating a detector (2) connected to a signal processor (4) configured to drive the detector according to the present disclosure, where connection between a cross-section of the detector and the signal processor is mimetically illustrated.

Referring to FIG. 9, the applied electrode (26) and the measurement electrode (27) may be arranged at a bottom surface of the channel (it is difficult to distinguish the main channel from the measurement channel because FIG. 9 illustrates a cross-section), where it can be noted that the applied electrode (26) is simultaneously applied with DC voltage and AC voltage. The signal measured by the measurement electrode (27) may be outputted to a signal detector (41) of the signal processor (4). However, it should be noted that FIG. 9 is for mimetic explanation, such that elements corresponding to AC or DC is not included in the signal processor (4), the detailed description of which will be made later.

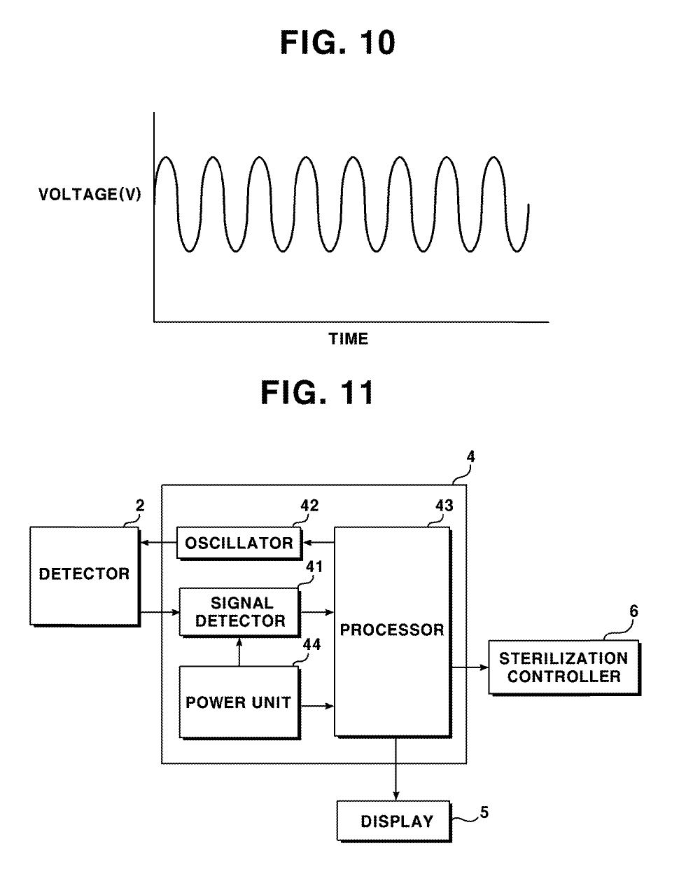

Referring to FIG. 9 again, the signal applied to the applied electrode (26) is simultaneously applied with the DC voltage and the AC voltage. That is, an AC voltage of a frequency to be measured is additionally applied as much as an optimized DC voltage, which corresponds to a waveform illustrated in FIG. 10.

FIG. 10 is an exemplary view illustrating a voltage applied to an electrode.

Referring to FIG. 10, the signal processor (4) may include a signal detector (41), an oscillator (42), a processor (43) and an electric source unit (44).

The signal detector (41) and the oscillator (42) of the signal processor (4) according to the present disclosure may correspond to an analogue signal processor, and the processor (43) may correspond to a digital signal processor. However, the present disclosure is not limited thereto. The digital signal processor may perform a signal processing by converting an analogue signal to a predetermined sampling speed in order to convert the analogue signal to a digital signal, and may process a signal by converting an analogue signal to a digital signal at a sampling speed of in the range of 100 sample/s to 1M sample/s.

The processor (43) may receive an electric power from the electric source unit (44), and when a predetermined signal applied with a DC voltage is applied to the oscillator (42), the oscillator (42) may oscillate a signal of relevant period and apply the oscillated signal to the applied electrode (26) of the detector (2). At this time, the oscillator (42) may be an oscillation element including a resistant element (R) and a capacitor element (C), may be an operational amplifier (OP-AMP), or may be realized by an element such as a crystal. The configuration of oscillator is well known to the skilled in the art such that no more elaboration thereto will be made. The signal outputted from the oscillator (42) may be a signal in which AC voltage and DC voltage are added that is explained by FIG. 10.

The signal applied to the applied electrode may pass through an electric field formed in the fluid and may be measured by the measurement electrode (27), and the signal measured by the measurement electrode (27) may be a signal that has changed in response to changes in impedance as illustrated in FIG. 8. At this time, in order to detect a minute fine change in signal measured by the measurement electrode (27), a signal detector (41) may filter a portion corresponding to a frequency band of the applied signal from the signal measured by the measurement electrode (27) and amplify only the signal portion. That is, the signal detector (41) may be formed with a pass filter of a predetermined band and an OP-AMP, or may be formed with a resistor and a capacitor only as explained above.

The processor (43) may receive the signal thus detected to increase a signal-to-noise-ratio (SNR) whereby presence/absence of particles inside a sample, sizes and types of particles may be determined. Furthermore, the processor (43) may output the signal thus processed through the display (5). In addition, a pollution degree of solution may be determined in response to concentration of particles using the signal detected by the signal detector (41), whereby the sterilization controller (6) may be controlled by activating a sterilization system. Any further actions belong to the skilled in the art such that no further elaboration thereto will be provided hereinafter.

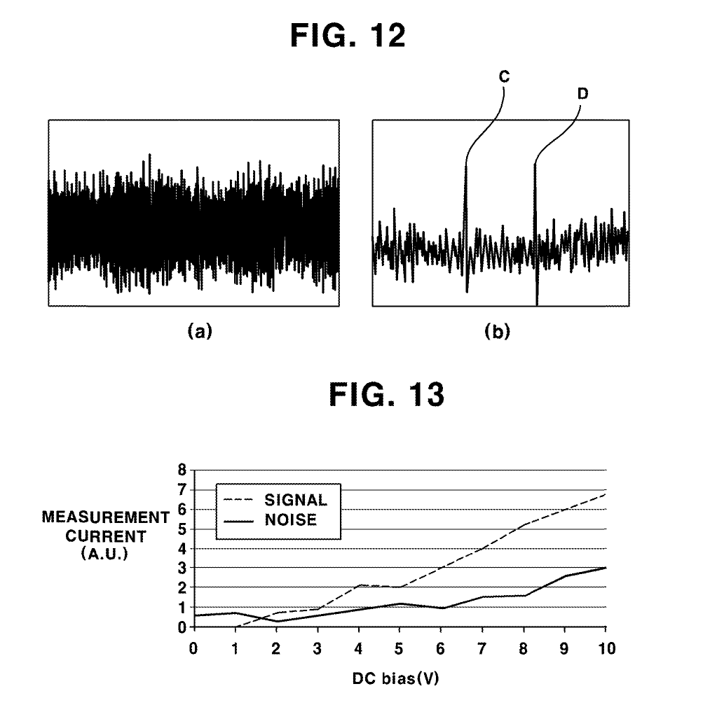

FIG. 12 is an exemplary view illustrating a signal characteristic detected by a signal detector.

Referring to FIG. 12, an electric signal outputted from the measurement electrode (27) goes through the filtering and partial amplification by the signal detector (41), whereby only the signal characteristic in response to the movement of particle is extracted.

Using FIG. 12(a), it can be ascertained that even if a particle in the conventional low conductivity solvent (purified water, city water or the like) passes a measurement area, a change in the electric signal by the particle is not detected as a separate characteristic. However, it can be ascertained that changes in the electric signal by movement of the particle are clearly detected (C, D) by the method of the present disclosure as shown in FIG. 12(b).

Meantime, FIG. 13 is an exemplary view illustrating changes in measurement in response to a DC voltage.

Referring to FIG. 13, although noise is greater than signal when no DC voltage is applied, it can be ascertained that the magnitude of signal is distinctively greater than the noise when a DC voltage exceeding 2V is applied. That is, it can be noted that limit in electric conductivity of solution can be eliminated by changes in DC voltage during particle detection inside the solution to thereby improve the particle detection performance.

The present disclosure can advantageously increase the electric conductivity of solvent and detect particles regardless of electric conductivity of solvent as well, whereby detection of particles in solvent of low electric conductivity can be enabled to thereby minimize sizes of chips and to reduce the prices thereof.

The following Table 1 explains comparative experiments for electric conductivity, where an electric conductivity in response to dilution ratio of electrolyte (e.g., isoton) and measurement possibility in a relevant solvent are compared and shown.

TABLE 1

| Electrolyte | Electric | Conventional | Present |
|---|---|---|---|
| dilution ratio | conductivity | counter method | disclosure |
| Initial state | 16.7 mS/cm | possible | possible |
| ½ diluted | 8.1 mS/cm | Possible | possible |
| ¼ diluted | 4.9 mS/cm | Impossible | possible |
| Water purifier | 5 μS/cm | impossible | possible |

As noted from the Table 1, the present disclosure can be applied to detection particles in a liquid of low electric conductivity, and a user can measure concentration of particles in solution that is desired to learn without any separate processing.

Although the present disclosure has been described in detail with reference to the foregoing embodiments and advantages, many alternatives, modifications, and variations will be apparent to those skilled in the art within the metes and bounds of the claims. Therefore, it should be understood that the above-described embodiments are not limited by any of the details of the foregoing description, unless otherwise specified, but rather should be construed broadly within the scope as defined in the appended claims

What is claimed is:

1. A particle detection apparatus, the apparatus comprising:
a detector configured to detect a concentration of particles in an inflowing solution using a first signal applied to a first electrode, the first signal including a direct current (DC) voltage and an alternating current (AC) voltage; and
a signal processor configured to provide the first signal to the detector and to detect a second signal measured by a second electrode.

2. A particle detection apparatus, the apparatus comprising:
a first main channel configured to receive the solution,
a second main channel configured to output the solution,
a measurement channel interposed between the first and second channels, and having a width narrower than that of the first and second main channels,
a first electrode on a surface of the first main channel,
a second electrode on a surface of the second main channel, and
a signal processor configured to provide a first signal to the first electrode and to detect a second signal measured by the second electrode,
wherein the first signal including a direct current (DC) voltage and an alternating current (AC) voltage.

3. The apparatus of claim 2, wherein the detector further comprises:
an injector configured to inject the solution into the first main channel, and
a discharger configured to discharge the solution from the second main channel.

4. The apparatus of claim 2, wherein the width of measurement channel is determined between two times to 50 times the size of a particle to be measured.

5. The apparatus of claim 2, wherein the DC voltage is in the range of 0.1V to 20V.

6. The apparatus of claim 2, wherein the AC voltage is in the range of 0.1V to 20V.

7. The apparatus of claim 2, wherein a frequency of the AC voltage is in the range of 100 Hz to 10 MHz.

8. The apparatus of claim 2, wherein the signal processor comprises:
a processor configured to generate a third signal of a predetermined period with the DC voltage,
an oscillator configured to oscillate the third signal to generate the first signal where the DC and AC voltages are coupled, and
a signal detector configured to filter the second signal from the second electrode by a predetermined band and amplify the filtered second signal.

9. A particle detection apparatus, the apparatus comprising:
a first channel;
a second channel connected to the first channel;
a third channel between the first and second channels and having a width narrower than that of the first and second channels;
a first electrode on a surface of the first channel; and
a second electrode on a surface of the second channel,
wherein a DC voltage and an AC voltage are simultaneously applied to the first electrode.

10. The apparatus of claim 9, wherein the DC voltage is in the range of 0.1V to 20V.

11. The apparatus of claim 9, wherein the AC voltage is in the range of 0.1V to 20V.

12. The apparatus of claim 9, wherein a frequency of the AC voltage is in the range of 100 Hz to 10 MHz.

13. The apparatus of claim 9, wherein the width of third channel is determined between two times to 50 times the size of a particle to be measured.

14. The apparatus of claim 9, wherein each of the first and second electrodes is manufactured by a semiconductor process.

15. The apparatus of claim 9, wherein each of the first and second electrodes includes any one of Pt, Cr, Ti, Cu, Ag, Au and Al.

16. The apparatus of claim 9, wherein each of the first, second and third channels is manufactured by a semiconductor process.

17. The apparatus of claim 9, wherein each of the first, second and third channels is made of non-conductive material.

18. The apparatus of claim 9, further comprising:
an injector configured to inject solution into the first channel at a part of the first channel.

19. The apparatus of claim 18, further comprising:
a discharger configured to discharge the solution at a part of the second channel.
